(19) United States
(12) Patent Application Publication
(10) Pub. No.: US 2026/0106429 A1
(43) Pub. Date: Apr. 16, 2026

(54) WAVELENGTH-LOCKED QUASI-UNIDIRECTIONAL RING CAVITY WITH DIFFRACTION GRATING OUTPUT COUPLER

(71) Applicant: Lumentum Operations LLC, San Jose, CA (US)

(72) Inventor: Kwun Sing CHAN, Ottawa (CA)

(21) Appl. No.: 19/198,454

(22) Filed: May 5, 2025

Related U.S. Application Data
(60) Provisional application No. 63/707,979, filed on Oct. 16, 2024.

(51) Int. Cl. H01S 3/083; H01S 3/08; H01S 3/13

(52) U.S. Cl. CPC H01S 3/083; H01S 3/08059; H01S 3/1305

(57) ABSTRACT

A ring-laser system for generating coherent optical radiation includes a ring cavity comprising: three or more reflectors configured to provide a forward-circulation pathway delineating a forward circulation within the ring cavity and a reverse-circulation pathway delineating a reverse circulation within the ring cavity, the forward-circulation pathway and the reverse-circulation pathway being overlapping, counter-directional optical pathways; and a gain medium disposed within the ring cavity that is bidirectionally incorporated into the forward-circulation pathway and the reverse-circulation pathway. The ring-laser system further includes a forward-drain optical pathway for tapping a portion of light from the forward-circulation pathway; a reverse-drain optical pathway for tapping a portion of light from the reverse-circulation pathway as optical feedback; a forward-source optical pathway for inserting additional light into the forward-circulation pathway; and an optical feedback component configured to optically couple the reverse-drain optical pathway to the forward-source optical pathway.

### CROSS-REFERENCE TO RELATED APPLICATION

This Patent Application claims priority to U.S. Provision Ser. No. 63/707,979, filed on Oct. 16, 2024, and entitled “QUASI-UNIDIRECTIONAL RING CAVITY WITH A DIFFRACTION GRATING OUTPUT COUPLER.” The disclosure of the prior Application is considered part of and is incorporated by reference into this Patent Application.

### TECHNICAL FIELD

The present disclosure relates generally to a ring-laser system with a diffraction grating output coupler.

### BACKGROUND

A ring-laser system typically uses a closed-loop optical path in which light circulates in a laser cavity, which is a ring-shaped cavity. This configuration can enhance specific properties, like directional coherence, by using elements like reflectors (mirrors or other optical components that direct the beam) and often includes a Faraday isolator. A gain medium is typically arranged in the ring-shaped cavity for amplifying the light within the ring-shaped cavity. Additionally, one of the mirrors in the ring-shaped cavity often serves as an output coupler, allowing a fraction of the circulating light to exit the ring-shaped cavity while keeping most of the light within the ring-shaped cavity to continue amplification. A Faraday isolator may be used to ensure unidirectional light travel around the ring, essentially preventing counter-propagating waves that can reduce the efficiency of the laser. The Faraday isolator, based on the Faraday effect, rotates the plane of polarization in one direction, ensuring that light traveling backward in the ring cavity is absorbed or diverted, which can create a produce a travelling-wave single-frequency (e.g., single wavelength) output.

### SUMMARY

In some implementations, a ring-laser system for generating coherent optical radiation includes a ring cavity configured to provide a forward-circulation pathway delineating a forward circulation within the ring cavity and a reverse-circulation pathway delineating a reverse circulation within the ring cavity, the forward-circulation pathway and the reverse-circulation pathway being overlapping, counter-directional optical pathways, the ring cavity comprising: at least three reflective junctions configured to provide optical coupling for providing the forward-circulation pathway and the reverse-circulation pathway; and a gain medium that is bidirectionally incorporated into the forward-circulation pathway and the reverse-circulation pathway; a forward-drain optical pathway delineating light coupled out of the forward-circulation pathway; a reverse-drain optical pathway delineating light coupled out of the reverse-circulation pathway; and a forward-source optical pathway delineating light to be coupled into the forward-circulation pathway; a reflective diffraction grating disposed at a reflective junction of the at least three reflective junctions, the reflective diffraction grating configured to: couple a first portion of an incident segment of the forward-circulation pathway to an ensuing segment of the forward-circulation pathway, couple a second portion of the incident segment of the forward-circulation pathway to the forward-drain optical pathway, couple a first portion of an incident segment of the reverse-circulation pathway to an ensuing segment of the reverse-circulation pathway, couple a second portion of the incident segment of the reverse-circulation pathway to the reverse-drain optical pathway in order to augment the reverse circulation; and couple a first portion of the forward-source optical pathway to the ensuing segment of the forward-circulation pathway in order to augment the forward circulation; and an optical feedback component configured to optically couple the reverse-drain optical pathway to the forward-source optical pathway.

In some implementations, a ring-laser system for generating coherent optical radiation includes a ring cavity comprising: three or more reflectors configured to provide a forward-circulation pathway delineating a forward circulation within the ring cavity and a reverse-circulation pathway delineating a reverse circulation within the ring cavity, the forward-circulation pathway and the reverse-circulation pathway being overlapping, counter-directional optical pathways; and a gain medium disposed within the ring cavity that is bidirectionally incorporated into the forward-circulation pathway and the reverse-circulation pathway; a forward-drain optical pathway for tapping a portion of light from the forward-circulation pathway; a reverse-drain optical pathway for tapping a portion of light from the reverse-circulation pathway as optical feedback; a forward-source optical pathway for inserting additional light into the forward-circulation pathway; and an optical feedback component configured to optically couple the reverse-drain optical pathway to the forward-source optical pathway, wherein the optical feedback, redirected from the reverse-drain optical pathway to the forward-source optical pathway by the optical feedback component, is configured to augment an optical signal in the forward-circulation pathway such that an optical mode in the forward-circulation pathway attains preferential gain in the gain medium relative to a corresponding optical mode in the reverse-circulation pathway.

In some implementations, a free-space ring-cavity laser system for generating coherent optical radiation at a wavelength includes a ring cavity configured to provide a forward-circulation pathway delineating a forward circulation within the ring cavity and a reverse-circulation pathway delineating a reverse circulation within the ring cavity; a gain medium disposed within the ring cavity that is bidirectionally incorporated into the forward-circulation pathway and the reverse-circulation pathway; an output pathway for coupling a portion of light from the forward-circulation pathway to a laser-system output; and a feedback pathway for unilaterally redirecting a portion of light from the reverse-circulation pathway into the forward-circulation pathway, wherein optical feedback on the feedback pathway is configured to establish a cavity mode of the forward circulation pathway at the wavelength as a dominant-power mode of the free-space ring-cavity laser system, and establish a cavity mode of the reverse-circulation pathway at the wavelength as an idle-power mode of the free-space ring-cavity laser system.

In some implementations, a laser system includes a ring cavity having a forward-circulation pathway and a reverse-circulation pathway for light of a predetermined narrow linewidth, the ring cavity including: a reflective diffraction grating that includes an output path from the ring cavity; a gain medium; and a plurality of reflectors; and a back reflector bidirectionally optically coupled with the reflective diffraction grating, wherein the reflective diffraction grating is configured to redirect light from the forward-circulation pathway to the output path, wherein the reflective diffraction grating is configured to redirect light from the reverse-circulation pathway to the back reflector, and wherein the reflective diffraction grating is configured to redirect light from the back reflector to the forward-circulation pathway.

In some implementations, a laser system includes a diffraction grating arranged at an output of a ring cavity and configured to couple output laser light, having a predetermine narrow linewidth, out of the ring cavity along an output path; a plurality of reflectors that, together with the diffraction grating, define the ring cavity, wherein the ring cavity is configured to operate in a startup operation mode and a steady-state operation mode, and wherein the ring cavity includes a forward-circulation pathway and a reverse-circulation pathway that is directionally counter to the forward-circulation pathway; a gain medium configured to generate laser light on the forward-circulation pathway and the reverse-circulation pathway of the ring cavity; and a back reflector optically coupled with the diffraction grating, wherein the diffraction grating and the back reflector are configured to, during the startup operation mode, redirect energy of the laser light, from the reverse-circulation pathway into the forward-circulation pathway such that, on each pass within the ring cavity, a total energy propagating along the reverse-circulation pathway is reduced and a total energy propagating along the forward-circulation pathway is increased, resulting in a steady-state condition corresponding to the steady-state operation mode, and wherein the ring cavity is configured to, during the steady-state operation mode, select the forward-circulation pathway as a dominant path for laser light in the ring cavity.

In some implementations, a laser system includes a diffraction grating arranged at an output of a ring cavity and configured to couple output laser light, having a predetermine narrow linewidth, out of the ring cavity along an output path; a plurality of reflectors that, together with the diffraction grating, define the ring cavity, wherein the ring cavity includes propagation paths, including a forward-circulation pathway and a reverse-circulation pathway, directionally counter to the forward-circulation pathway; a gain medium configured to generate laser light on the propagation paths of the ring cavity; and a back reflector optically coupled with the diffraction grating, wherein the diffraction grating is configured to use a back reflection from the back reflector to capture a first portion of the laser light from the reverse-circulation pathway, and redirect the first portion of the laser light into the forward-circulation pathway to generate a forward propagating light for producing the output laser light.

### BRIEF DESCRIPTION OF THE DRAWINGS

FIGS. 1A-1D show a ring-laser system for generating coherent optical radiation according to one or more implementations.

FIG. 2A shows an interaction with a reflective diffraction grating of the ring-laser system according to one or more implementations.

FIG. 2B shows an interaction with the reflective diffraction grating of the ring-laser system according to one or more implementations.

FIG. 2C shows an interaction with the reflective diffraction grating of the ring-laser system according to one or more implementations.

FIG. 2D shows an interaction with the reflective diffraction grating of the ring-laser system according to one or more implementations.

### DETAILED DESCRIPTION

The following detailed description of example implementations refers to the accompanying drawings. The same reference numbers in different drawings may identify the same or similar elements.

In some cases, a Littman external cavity can be a linear cavity (e.g., components may be arranged in a linear configuration), which can result in spatial hole burning. For example, a standing wave external cavity laser (e.g., in a Littrow configuration or a Littman-Metcalf configuration) provides wavelength selection, but suffers from hole burning effects (e.g., in the standing wave cavity) and lower power efficiency. On the other hand, a ring laser may utilize an optical isolator, such as a Faraday isolator, to control a directionality of a laser operation. Wavelength selectivity can be achieved with additional in-cavity tuning elements and/or external wavelength selective feedback. However, the optical isolator increases a size, weight, and cost of the ring laser, and typically makes the ring laser less power efficient.

Some implementations described herein include an optical system (e.g., a laser system). The optical system may have a ring cavity configuration defining a ring cavity. The optical system may be configured to establish uni-directional propagation (e.g., of a propagating wave). Further, the optical system may not utilize an intra-cavity optical isolator (e.g., a Faraday isolator or another type of optical isolator). Omitting the optical isolator may reduce (or optimize) a size, weight, and cost of the optical system, and may increase a power efficiency of the optical system.

In some implementations, the optical system may be configured as a quasi-unidirectional ring cavity that does not utilize an optical isolator. The optical system may include two or more reflectors (e.g., two or more high reflectivity (HR) reflectors), which may be configured as tuning mirrors, a gain medium, a reflective diffraction grating, and an optical feedback component, such as a back reflector, that is optically coupled with the reflective diffraction grating. The optical feedback component is be arranged outside of the ring cavity, but aids in establishing directional dominance in a preferred direction (e.g., along a forward-circulation pathway).

The configuration of the optical system may be “quasi-unidirectional” because the optical system is output coupled in one direction, but may not be unidirectional (e.g., because energy may be allowed to build up in a reverse-circulation pathway). In some implementations, energy associated with a reverse-circulating wave may be re-directed (or at least partially re-directed) to the forward-circulation pathway on each pass of the reverse-circulating wave. Accordingly, in some implementations, the optical system may be optimal for applications where wavelength stability, size, and cost are critical concerns (e.g., because some optical elements, such as an optical isolator, a waveplate, a polarizer, and/or other optical elements can be omitted).

The optical system may be configured, by design, to disallow unwanted orders (e.g., unwanted orders of diffraction or unwanted orders of reflection). In some implementations the optical system may be configured to enable at least one of: a 0th order associated with a forward-circulating wave to be output coupled (e.g., as a cavity output); a 1st order associated with the forward-circulating wave to be circulated within the ring cavity of the optical system; a 1st order associated with the reverse-circulating wave to be circulated within the ring cavity of the optical system; a 0th order associated with the reverse-circulating wave to be back reflected; or a back reflected 0th order associated with the reverse-circulating wave to be partitioned into at least one of a 0th order reflection (e.g., that co-aligns with the forward-circulating wave) or a 1st order reflection (e.g., that co-aligns with the cavity output).

In some implementations, a differential in loss between the forward-circulation pathway and the reverse-circulation pathway may be sufficient such as to cause the forward-circulating wave to win (or dominate) a gain competition with the reverse-circulating wave. This may set a directional preference (e.g., directional dominance) for light (e.g., laser light) to travel (e.g., in an early stage of pumping), which may allow quasi-unidirectional stimulated amplification to occur.

The reflective diffraction grating and the back reflector may be bi-directionally coupled to avoid spatial hole burning (e.g., that otherwise results in linear cavities), and therefore improve a power efficiency of the optical system. The back reflector may facilitate setting of the directional preference for the ring cavity (e.g., during an early phase of lasing). For example, on a start-up of the optical system, stimulated emission propagations produced by the gain medium in two directions (e.g., a forward-circulating direction and a reverse-circulation direction) are independent, and phases are not initially correlated. As configured, the optical system may allow light to only leak from the reverse-circulation pathway to the forward-circulation pathway (and not from the forward-circulation pathway to the reverse-circulation pathway); and therefore, eventually, leakage from reverse-circulation pathway to forward-circulation pathway will win a gain competition to dominate the ring cavity.

In some implementations, in a first scenario, forward propagation and reverse propagation build-ups may be in-phase. A reverse-circulating wave may be partially redirected into the forward-circulation pathway. Accordingly, power grows (e.g., exponentially) in the forward-circulation pathway while the reverse-circulating wave loses power (e.g., each round-trip). The forward-circulating wave therefore dominates the ring cavity to establish directional dominance in the ring cavity along the forward-circulation pathway.

In some implementations, in a second scenario, forward propagation and reverse propagation build-ups may be out-of-phase. The reverse-circulating wave may be partially redirected to the forward-circulation pathway, and may destructively interfere with the forward-circulating wave. Forward propagation therefore may be unable to build up, but the reverse-circulating wave leaks light into the forward-circulation pathway, which may build up in-phase with the reverse-circulating wave. Conditions then become similar to the first scenario, and the forward-circulating wave may therefore (eventually) dominate the ring cavity to establish directional dominance in the ring cavity along the forward-circulation pathway.

In some implementations, in a third scenario, the forward-circulating wave may experience a phase shift of a different amount upon each round trip, such as based on a relative field amplitude when interfering with the reverse-circulating wave. Eventually, conditions become similar to the first scenario or the second scenario, and the forward-circulating wave may therefore (eventually) dominate the ring cavity to establish directional dominance in the ring cavity along the forward-circulation pathway.

Accordingly, some implementations enable uni-directional wave propagation in a ring cavity without the need for an optical isolator.

In some implementations, diffraction efficiencies for the various paths of the optical system may be represented as follows:
Eff0+Eff1=1, where Eff0 is efficiency of a 0th order of a forward-circulating wave or a reverse-circulating wave and Eff1 is efficiency of a 1st order of the forward-circulating wave or the reverse-circulating wave,
Forward-circulation pathway coupling=Eff1 to cavity forward direction, Eff0 to cavity output,
Reverse-circulation pathway coupling=Eff1 to cavity reverse direction, Eff0 to back reflector,
Back reflected light coupling=Eff0 to cavity forward circulation, Eff1 to cavity output,
And so, reverse-circulation pathway coupling=Eff1 to cavity reverse direction, (Eff0 to back reflector)×(Eff0 to forward-circulation pathway), (Eff0 to back reflector)×(Eff1 to cavity output)

In some implementations, an important factor is whether light from the back reflector of the optical system that couples to the forward-circulation pathway or the cavity output is in-phase or out-of-phase with the light already present in the forward-circulation pathway. The phase of the back reflector may be adjusted to ensure that the reflected light is in-phase with the light already propagating in the forward-circulation pathway, so that a forward-circulating light intensity is increased rather than decreased. In some implementations, light leaks from the reverse-circulation pathway to the forward-circulation pathway, but not from the forward-circulation pathway to the reverse-circulation pathway. As a result, eventually, the leakage from the reverse-circulation pathway to the forward-circulation pathway may cause the two propagations to be in phase with each other. In some implementations, a small leakage from the forward-circulation pathway to the reverse-circulation pathway may be utilized to ensure that the reverse-circulating wave remains in phase with the forward-circulating wave (e.g., even when an intensity of the reverse-circulating wave is reduced).

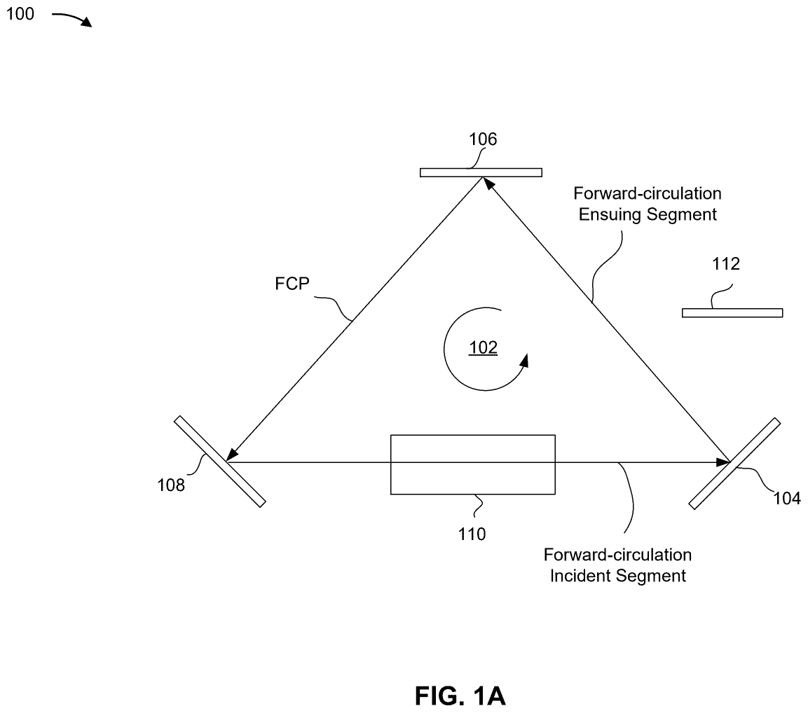

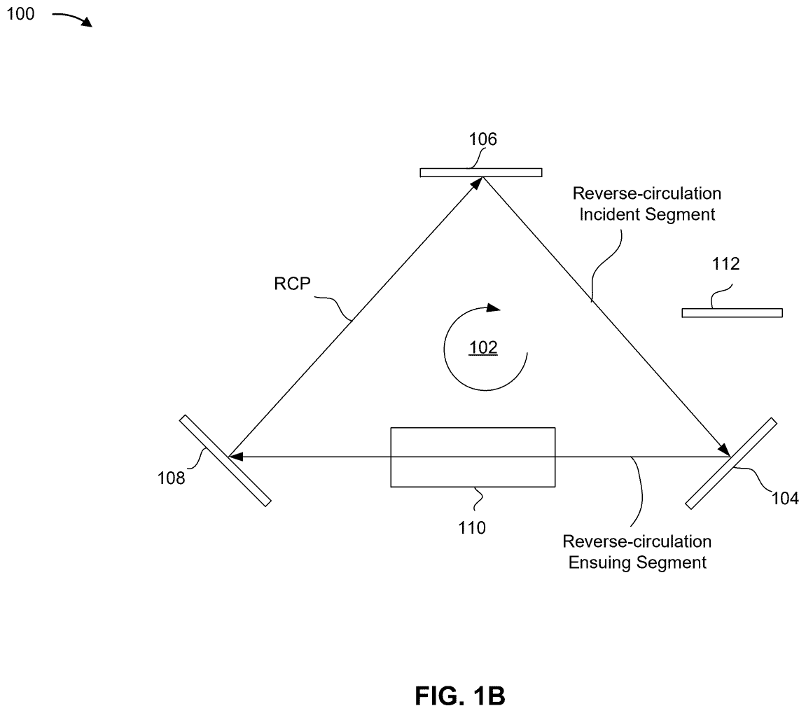

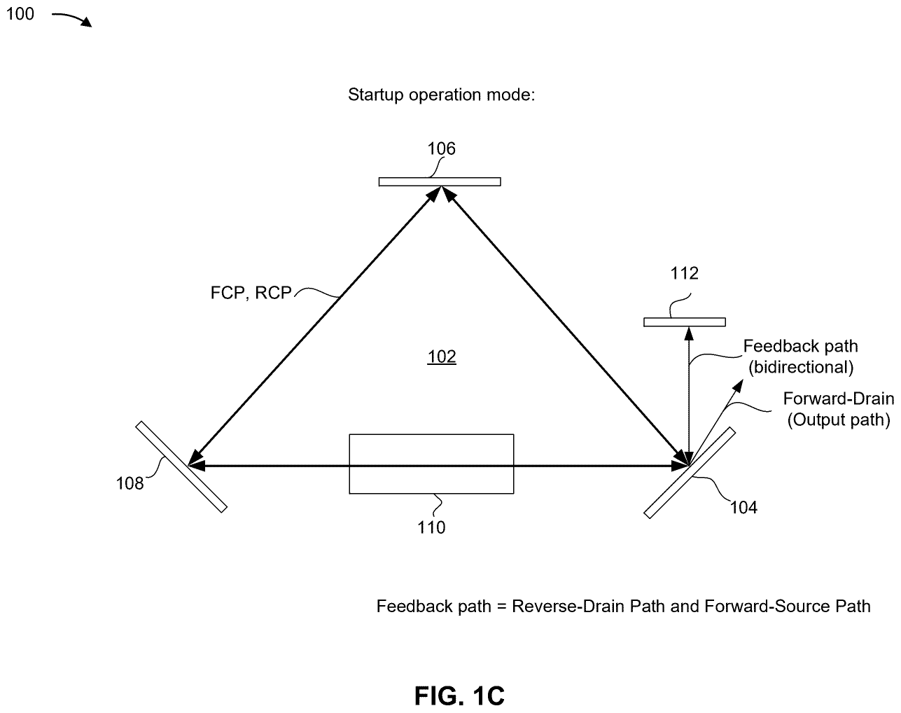

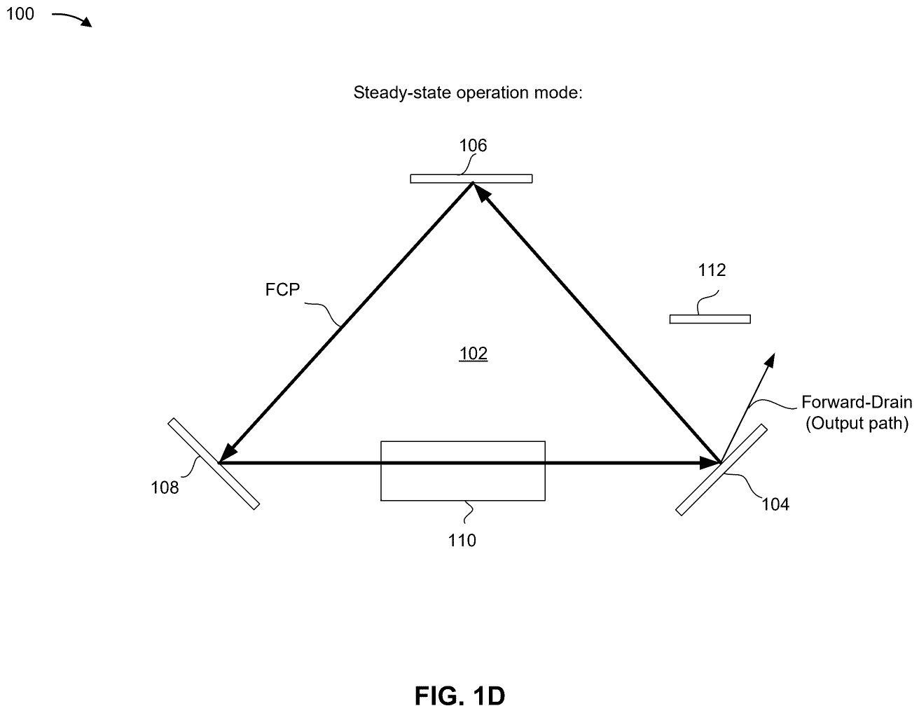

FIGS. 1A-1D show a ring-laser system 100 for generating coherent optical radiation according to one or more implementations. The ring-laser system 100 may be a free-space ring-cavity laser system for generating the coherent optical radiation at a wavelength or at a predetermined narrow linewidth.

FIG. 1A illustrates a forward-circulation pathway (FCP) of the ring cavity 102. FIG. 1B illustrates a reverse-circulation pathway (RCP) of the ring cavity 102. FIG. 1C illustrates a startup operation mode of the ring-laser system 100 during which light propagates bidirectional within the ring-laser system 100 prior to directional dominance being established in a preferred direction. The ring-laser system 100 includes a ring cavity 102 configured to provide the forward-circulation pathway delineating a forward circulation within the ring cavity 102 and the reverse-circulation pathway delineating a reverse circulation within the ring cavity 102. The forward-circulation pathway and the reverse-circulation pathway are overlapping, counter-directional optical pathways. FIG. 1D illustrates a steady-state operation mode of the ring-laser system 100 that is established once directional dominance is established in the forward-circulation pathway (e.g., the preferred direction).

The ring cavity 102 may include at least three reflective junctions configured to provide optical coupling for providing the forward-circulation pathway and the reverse-circulation pathway. For example, the ring cavity 102 may include a reflective diffraction grating 104 disposed at a first reflective junction of the at least three reflective junctions, a first reflector 106 disposed at a second reflective junction of the at least three reflective junctions, and a second reflector 108 disposed at a third reflective junction of the at least three reflective junctions. The reflective junctions are configured to provide optical coupling of respective incident segments of the forward-circulation pathway and the reverse-circulation pathway to respective ensuing segments of the forward-circulation pathway and the reverse-circulation pathway. The ring cavity 102 may further include a gain medium 110 that is bidirectionally incorporated into the forward-circulation pathway and the reverse-circulation pathway.

An incident segment of the forward-circulation pathway is a forward-circulation segment that is incident on the reflective diffraction grating 104. An ensuing segment of the forward-circulation pathway is a forward-circulation segment that is a continuation of the forward-circulation pathway that continues from the reflective diffraction grating 104. An incident segment of the reverse-circulation pathway is a reverse-circulation segment that is incident on the reflective diffraction grating 104. An ensuing segment of the reverse-circulation pathway is a reverse-circulation segment that is a continuation of the reverse-circulation pathway that continues from the reflective diffraction grating 104.

The ring-laser system 100 may further include an optical feedback component 112 that is bidirectionally coupled to the reflective diffraction grating 104. In some implementations, the optical feedback component 112 may be a back reflector that is bidirectionally coupled to the reflective diffraction grating. The reflective diffraction grating 104 and the optical feedback component 112 may be coupled by a feedback pathway for unilaterally redirecting a portion of light (e.g., a fraction of light) from the reverse-circulation pathway into the forward-circulation pathway.

The ring-laser system 100 may further include a forward-drain optical pathway delineating light coupled out of the forward-circulation pathway. The forward-drain optical pathway may correspond to an output path of the ring-laser system 100. In other words, the forward-drain optical pathway may be a laser-system output path from which the coherent optical radiation is output from the ring-laser system 100. The forward-drain optical pathway may “drain”, tap, or otherwise output a portion of light (e.g., forward-circulating light) or energy circulating on the forward-circulation pathway. Thus, the forward-drain optical pathway may be for tapping a portion of light from the forward-circulation pathway.

The ring-laser system 100 may further include a reverse-drain optical pathway delineating light coupled out of the reverse-circulation pathway. The reverse-drain optical pathway may extend from the reflective diffraction grating 104 to the optical feedback component 112 (e.g., the back reflector). For instance, the reverse-drain optical path, from the reflective diffraction grating 104 to the optical feedback component 112, may be interior to an angle between an incident angle of forward-circulation path on the reflective diffraction grating 104 and the forward-drain optical path. The reverse-drain optical pathway may be configured to “drain” or tap a portion of light (e.g., forward-circulating light) or energy circulating on the reverse-circulation pathway from the reverse-circulation pathway. For example, light may leak from the reverse-circulation pathway into the reverse-drain optical pathway. Thus, the reverse-drain optical pathway may be for tapping a portion of light from the reverse-circulation pathway as optical feedback.

The ring-laser system 100 may further include a forward-source optical pathway delineating light to be coupled into the forward-circulation pathway. The forward-source optical pathway may be configured to “source” or inject a portion of light (e.g., back reflected light) or energy into the forward-circulation pathway. Thus, the forward-source optical pathway may be for inserting additional light into the forward-circulation pathway. The forward-source optical pathway may extend from the optical feedback component 112 (e.g., the back reflector) to the reflective diffraction grating 104. Thus, the optical feedback component 112 may be bidirectionally coupled to the reflective diffraction grating 104 by the reverse-drain optical pathway and the forward-source optical pathway. In particular, the optical feedback component 112 may optically couple the reverse-drain optical pathway to the forward-source optical pathway. For example, the optical feedback component 112 may back reflect the reverse-drain optical pathway back to the reflective diffraction grating 104 as the forward-source optical pathway. Thus, the reverse-drain optical pathway and the forward-source optical pathway are overlapping, counter-directional optical pathways. The reverse-drain optical pathway and the forward-source optical pathway may form the feedback pathway for unilaterally redirecting a portion of light (e.g., a fraction of light) from the reverse-circulation pathway into the forward-circulation pathway.

The reflective diffraction grating 104 may couple a first portion of an incident segment of the forward-circulation pathway to an ensuing segment of the forward-circulation pathway. Additionally, the reflective diffraction grating 104 may couple a second portion of the incident segment of the forward-circulation pathway to the forward-drain optical pathway. For example, the reflective diffraction grating 104 may split laser light from the forward-circulation pathway between a 0th order redirection to the output path and a 1st order redirection to the forward-circulation pathway.

The reflective diffraction grating 104 may couple a first portion of an incident segment of the reverse-circulation pathway to an ensuing segment of the reverse-circulation pathway. Additionally, the reflective diffraction grating 104 may couple a second portion of the incident segment of the reverse-circulation pathway to the reverse-drain optical pathway in order to augment the reverse circulation. For example, the reflective diffraction grating 104 may split laser light from the reverse-circulation pathway between a 0th order redirection to the back reflector and a 1st order redirection to the reverse-circulation pathway, The reflective diffraction grating 104 may couple a first portion of the forward-source optical pathway to the ensuing segment of the forward-circulation pathway in order to augment the forward circulation. Additionally, the reflective diffraction grating 104 may couple a second portion of the forward-source optical pathway to the forward-drain optical pathway. For example, the reflective diffraction grating 104 may split laser light from the back reflector between a 0th order redirection to the forward-circulation pathway and a 1st order redirection to the output path. Thus, the reflective diffraction grating 104 may use a back reflection from the optical feedback component 112 to capture a first portion of the laser light from the reverse-circulation pathway, and redirect the first portion of the laser light into the forward-circulation pathway to generate a forward propagating light for producing the output laser light. Moreover, wherein the reflective diffraction grating 104 may use the back reflection from the optical feedback component 112 to capture a second portion of the laser light from the reverse-circulation pathway, and redirect the second portion of the laser light into the forward-drain optical pathway (e.g., the output path). The reflective diffraction grating 104 may direct a third portion of the laser light from the reverse-circulation pathway further along the reverse-circulation pathway.

The reflective diffraction grating 104 may create an energy imbalance between the reverse-circulation pathway and the forward-circulation pathway such that, among the forward-circulation pathway and the reverse-circulation pathway, the forward-circulation pathway becomes a dominant propagation path within the ring cavity 102. For example, the reflective diffraction grating 104 may use a back reflection from the optical feedback component 112 to redirect energy from the reverse-circulation path into the forward-circulation path.

FIG. 1C shows the startup operation mode of the ring-laser system 100. Initially, the gain medium 110 is stimulated to emit stimulate emissions in two directions (e.g., a forward-circulating direction and a reverse-circulation direction). Thus, the gain medium 110 may generate laser light on the forward-circulation pathway and the reverse-circulation pathway of the ring cavity 102. The reflective diffraction grating 104 and the optical feedback component 112 are bidirectionally coupled by the reverse-drain optical pathway and the forward-source optical pathway such that greater effective optical gain is provided for the forward circulation of light on the forward-circulation pathway than for the reverse circulation of light on the reverse-circulation pathway, thereby producing a steady-state operating mode having a major portion of mode power in the forward-circulation pathway and a minor portion of the mode power in the reverse-circulation pathway. In other words, the optical feedback, redirected from the reverse-drain optical pathway to the forward-source optical pathway by the optical feedback component 112, is configured to augment an optical signal in the forward-circulation pathway such that an optical mode in the forward-circulation pathway attains preferential gain in the gain medium 110 relative to a corresponding optical mode in the reverse-circulation pathway. Thus, the optical feedback is configured to establish a cavity mode of the forward circulation pathway at the wavelength as a dominant-power mode of the ring-laser system 100, and establish a cavity mode of the reverse-circulation pathway at the wavelength as an idle-power mode of the ring-laser system 100. The reflective diffraction grating 104 and the optical feedback component 112 are configured to establish the steady-state operation mode by establishing directional dominance along the forward-circulation path.

In some implementations, the reflective diffraction grating 104 and the optical feedback component 112 are configured to, during the startup operation mode, redirect energy of the laser light, from the reverse-circulation pathway into the forward-circulation pathway such that, on each pass within the ring cavity 102, a total energy propagating along the reverse-circulation pathway is reduced and a total energy propagating along the forward-circulation pathway is increased, resulting in a steady-state condition corresponding to the steady-state operation mode. Thus, the ring cavity 102 may, during the steady-state operation mode, select the forward-circulation pathway as a dominant path for laser light in the ring cavity 102. FIG. 1D illustrates the steady-state operation mode of the ring-laser system 100 that is established once directional dominance is established in the forward-circulation pathway (e.g., the preferred direction). In some implementations, a minor portion of light may continue to circulate in the reverse-circulation pathway, which continues to leak into the forward-circulation pathway via the reflective diffraction grating 104 and the optical feedback component 112, as described above. Thus, in steady-state operation mode a minor portion of the mode power in the reverse-circulation pathway is established such that reverse-circulation pathway is in an idle-power mode at the desired wavelength.

Accordingly, the reflective diffraction grating 104 and the optical feedback component 112 are bidirectionally coupled by the reverse-drain optical pathway and the forward-source optical pathway such that a portion of optical energy coupled out of the reverse-circulation pathway by the reverse-drain optical pathway is redirected into the forward-circulation pathway. In other words, the reflective diffraction grating 104 and the optical feedback component 112 are bidirectionally coupled by the reverse-drain optical pathway and the forward-source optical pathway such that the reverse circulation is augmented negatively and the forward circulation is augmented positively for establishing directional dominance along the forward-circulation pathway. The reflective diffraction grating 104 and the optical feedback component 112 are bidirectionally coupled by the reverse-drain optical pathway and the forward-source optical pathway such that greater effective optical gain is provided for the forward circulation on the forward-circulation pathway than for the reverse circulation on the reverse-circulation pathway, thereby producing the steady-state operating mode having a major portion of mode power in the forward-circulation pathway and a minor portion of the mode power in the reverse-circulation pathway.

The ring cavity 102 is configured to circulate light having a predetermined wavelength. In order to ensure that the ring cavity 102 circulates light having only the predetermined wavelength, the reflective diffraction grating 104 may be configured such that wavelengths that are different from the predetermined wavelength are directed outside of the forward-circulation path and the reverse-circulation path. In other words, the reflective diffraction grating 104 may have a grating period configured to circulate the predetermined wavelength within the ring cavity 102, output the predetermined wavelength along the forward-drain optical pathway, and disallow other wavelengths (e.g., wavelengths that are different from the predetermined wavelength) from circulating within the ring cavity 102. For example, the reflective diffraction grating 104 may allow only 0^{th} order and 1^{st} order redirections of the predetermined wavelength from being circulated within the ring cavity 102. Additionally, the reflective diffraction grating 104 may disallow 2^{nd} or higher order redirections from being circulated within the ring cavity 102.

As indicated above, FIGS. 1A-1D are provided merely as examples. Other examples may differ from what is described with regard to FIGS. 1A-1D.

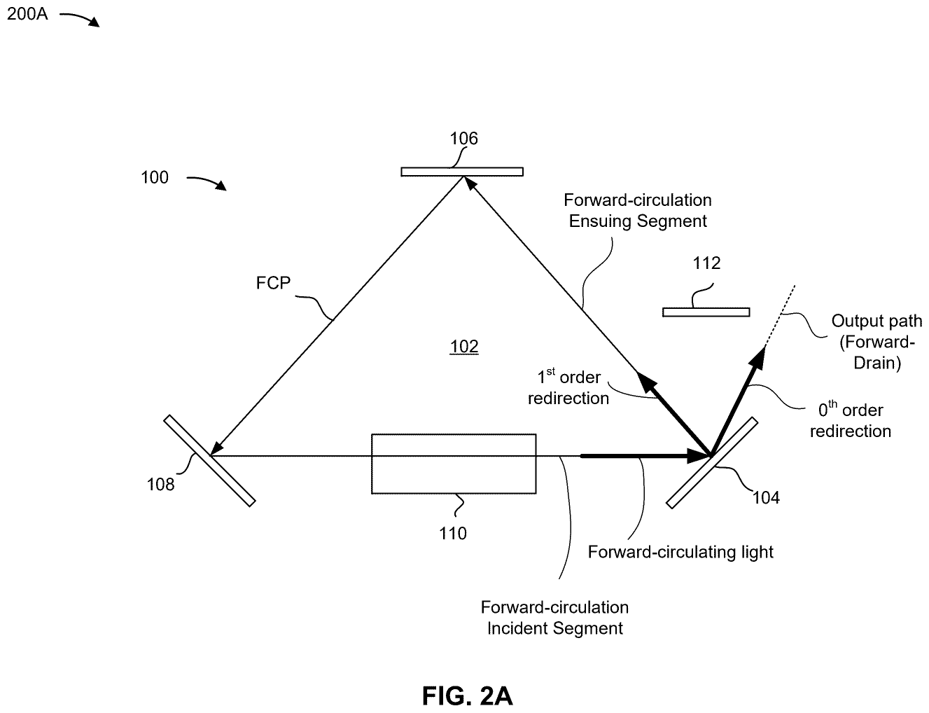

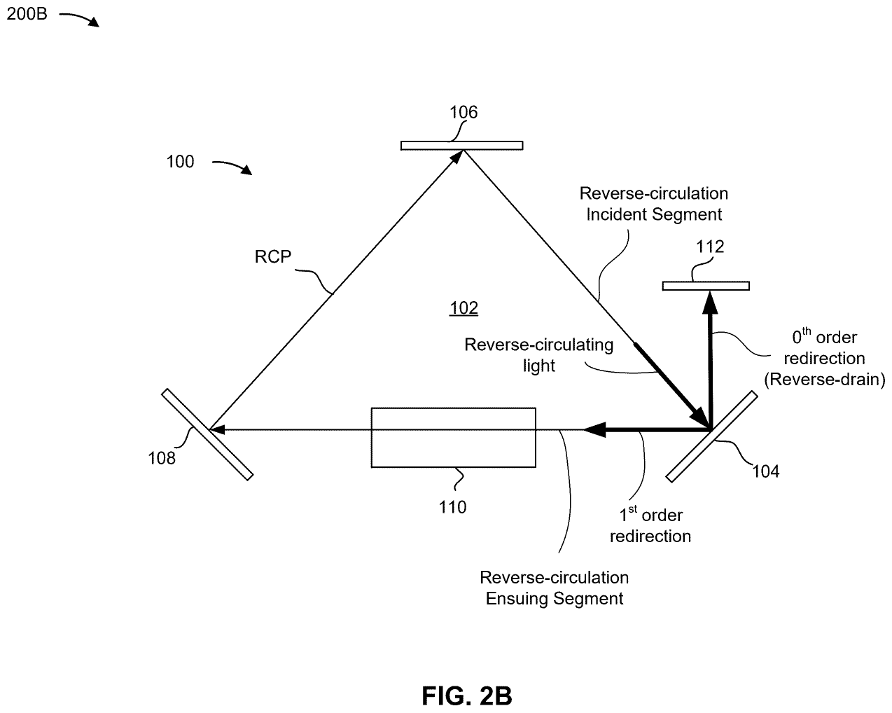

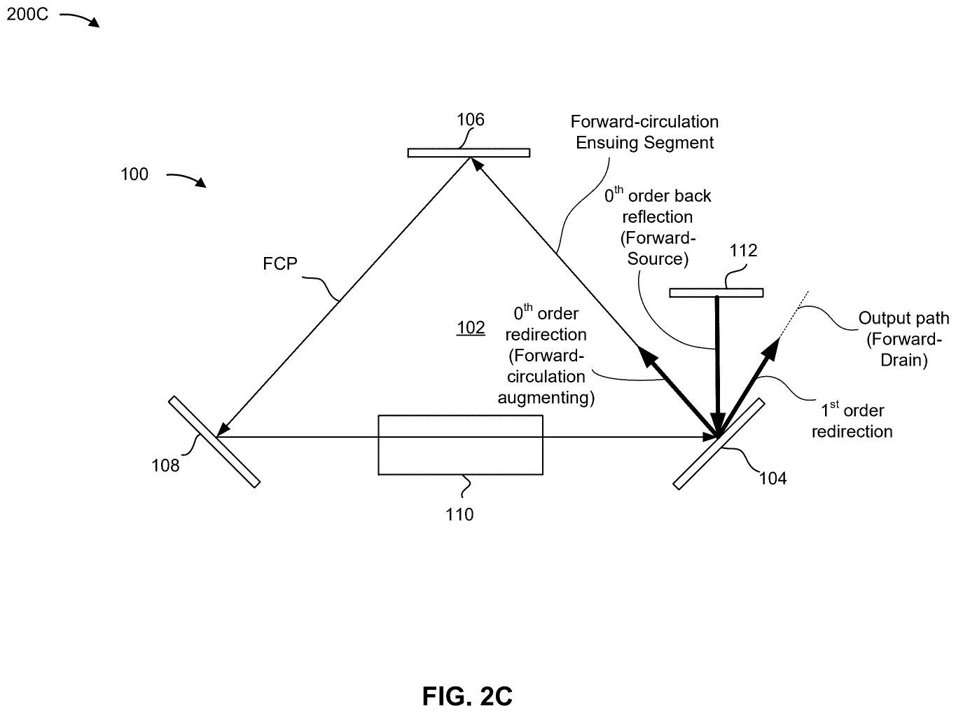

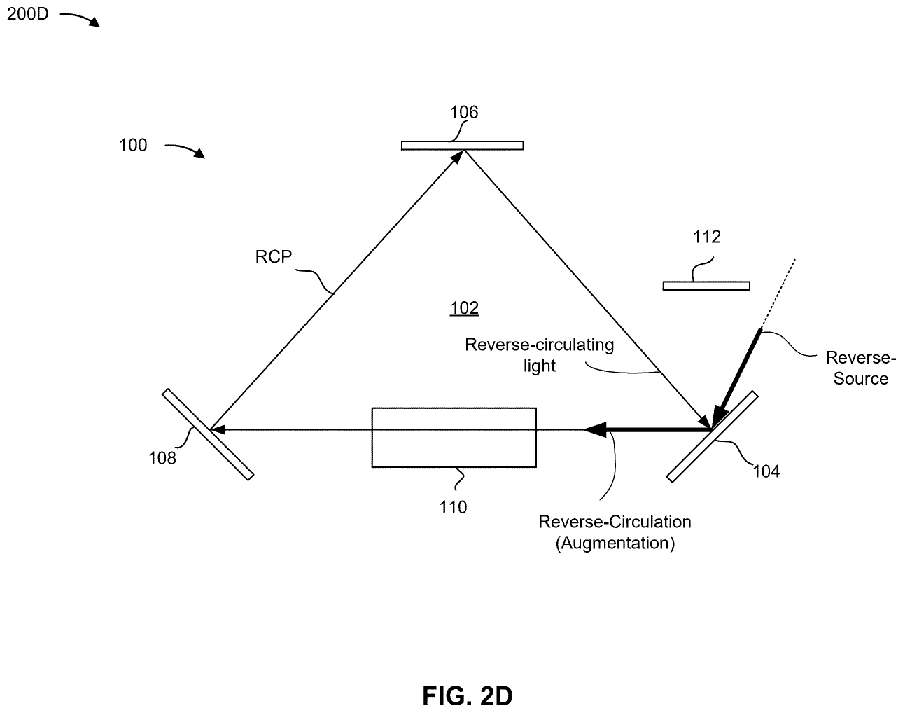

FIG. 2A shows an interaction 200A with the reflective diffraction grating 104 of the ring-laser system 100 according to one or more implementations. The reflective diffraction grating is configured such that the forward-drain optical pathway, from the incident segment of the forward-circulation pathway, is a 0th order redirection, and the ensuing segment of the forward-circulation pathway, from the incident segment of the forward-circulation pathway, is a 1st order redirection. In other words, the reflective diffraction grating 104 may redirect a first portion of laser light from the forward-circulation pathway to the forward-drain optical pathway (e.g., the output path) as a 0th order redirection. Additionally, the reflective diffraction grating 104 may redirect a second portion of laser light from the forward-circulation pathway to the forward-circulation pathway as a 1st order redirection.

As indicated above, FIG. 2A is provided merely as an example. Other examples may differ from what is described with regard to FIG. 2A.

FIG. 2B shows an interaction 200B with the reflective diffraction grating 104 of the ring-laser system 100 according to one or more implementations. The reflective diffraction grating 104 is configured such that the reverse-drain optical pathway, from the incident segment of the reverse-circulation pathway, is a 0th order redirection, and the ensuing segment of the reverse-circulation pathway, from the incident segment of the reverse-circulation pathway, is a 1st order redirection. Thus, the reflective diffraction grating 104 is configured such that redirecting from the incident segment of the reverse-circulation pathway to the optical feedback component 112 via the reverse-drain optical pathway is a 0th order redirection. In other words, the reflective diffraction grating 104 may redirect a first portion of laser light from the reverse-circulation pathway to the optical feedback component 112 as a 0th order redirection. Additionally, the reflective diffraction grating 104 may redirect a second portion of laser light from the reverse-circulation pathway to the reverse-circulation pathway as a 1st order redirection.

As indicated above, FIG. 2B is provided merely as an example. Other examples may differ from what is described with regard to FIG. 2B.

FIG. 2C shows an interaction 200C with the reflective diffraction grating 104 of the ring-laser system 100 according to one or more implementations. The reflective diffraction grating 104 is configured such that the ensuing segment of the forward-circulation pathway, from the forward-source optical pathway, is a 0th order redirection, and the forward-drain optical pathway, from the forward-source optical pathway, is a 1st order redirection. Thus, the reflective diffraction grating 104 is configured such that redirecting the forward-source optical pathway, from the optical feedback component 112, to the ensuing segment of the forward-circulation pathway is a 0th order redirection. In other words, the reflective diffraction grating 104 may redirect a first portion of laser light from the optical feedback component 112 to the forward-circulation pathway as a 0th order redirection. Additionally, the reflective diffraction grating 104 may redirect a second portion of laser light from the optical feedback component 112 to the forward-drain optical pathway (e.g., the output path) as a 1st order redirection.

As indicated above, FIG. 2C is provided merely as an example. Other examples may differ from what is described with regard to FIG. 2C.

FIG. 2D shows an interaction 200D with the reflective diffraction grating 104 of the ring-laser system 100 according to one or more implementations. The reflective diffraction grating 104 may couple a reverse-source optical pathway to the ensuing segment of the reverse-circulation pathway for inserting additional light into the reverse-circulation pathway. The reverse-source optical pathway and the forward-drain optical pathway may be overlapping, counter-directional optical pathways. The additional light may be inserted into the reverse-circulation pathway for augmenting the reverse circulation of the reverse-circulation pathway (e.g., for augmenting an optical signal in the reverse-circulation pathway). The additional light may be inserted into the reverse-circulation pathway for augmenting a phase and/or energy of the reverse circulation to facilitate the forward circulation in obtaining directional dominance.

As indicated above, FIG. 2D is provided merely as an example. Other examples may differ from what is described with regard to FIG. 2D.

The following provides an overview of some Aspects of the present disclosure:

Aspect 1: A ring-laser system for generating coherent optical radiation, comprising: a ring cavity configured to provide a forward-circulation pathway delineating a forward circulation within the ring cavity and a reverse-circulation pathway delineating a reverse circulation within the ring cavity, the forward-circulation pathway and the reverse-circulation pathway being overlapping, counter-directional optical pathways, the ring cavity comprising: at least three reflective junctions configured to provide optical coupling for providing the forward-circulation pathway and the reverse-circulation pathway; and a gain medium that is bidirectionally incorporated into the forward-circulation pathway and the reverse-circulation pathway; a forward-drain optical pathway delineating light coupled out of the forward-circulation pathway; a reverse-drain optical pathway delineating light coupled out of the reverse-circulation pathway; and a forward-source optical pathway delineating light to be coupled into the forward-circulation pathway; a reflective diffraction grating disposed at a reflective junction of the at least three reflective junctions, the reflective diffraction grating configured to: couple a first portion of an incident segment of the forward-circulation pathway to an ensuing segment of the forward-circulation pathway, couple a second portion of the incident segment of the forward-circulation pathway to the forward-drain optical pathway, couple a first portion of an incident segment of the reverse-circulation pathway to an ensuing segment of the reverse-circulation pathway, couple a second portion of the incident segment of the reverse-circulation pathway to the reverse-drain optical pathway in order to augment the reverse circulation; and couple a first portion of the forward-source optical pathway to the ensuing segment of the forward-circulation pathway in order to augment the forward circulation; and an optical feedback component configured to optically couple the reverse-drain optical pathway to the forward-source optical pathway.

Aspect 2: The ring-laser system of Aspect 1, wherein the reflective diffraction grating is configured to couple a second portion of the forward-source optical pathway to the forward-drain optical pathway.

Aspect 3: The ring-laser system of any of Aspects 1-2, wherein the forward-drain optical pathway is a laser-system output path from which the coherent optical radiation is output from the ring-laser system.

Aspect 4: The ring-laser system of any of Aspects 1-3, wherein the optical feedback component is a back reflector that is bidirectionally coupled to the reflective diffraction grating by the reverse-drain optical pathway and the forward-source optical pathway.

Aspect 5: The ring-laser system of any of Aspects 1-4, wherein the optical feedback component is configured to back reflect the reverse-drain optical pathway back to the reflective diffraction grating as the forward-source optical pathway, the reverse-drain optical pathway and the forward-source optical pathway being overlapping, counter-directional optical pathways.

Aspect 6: The laser system of any of Aspects 1-5, wherein the reflective diffraction grating is configured such that the forward-drain optical pathway, from the incident segment of the forward-circulation pathway, is a 0th order redirection, and the ensuing segment of the forward-circulation pathway, from the incident segment of the forward-circulation pathway, is a 1st order redirection.

Aspect 7: The laser system of any of Aspects 1-6, wherein the reflective diffraction grating is configured such that the reverse-drain optical pathway, from the incident segment of the reverse-circulation pathway, is a 0th order redirection, and the ensuing segment of the reverse-circulation pathway, from the incident segment of the reverse-circulation pathway, is a 1st order redirection.

Aspect 8: The laser system of any of Aspects 1-7, wherein the reflective diffraction grating is configured such that the ensuing segment of the forward-circulation pathway, from the forward-source optical pathway, is a 0th order redirection, and the forward-drain optical pathway, from the forward-source optical pathway, is a 1st order redirection.

Aspect 9: The laser system of any of Aspects 1-8, wherein the reflective diffraction grating is configured such that redirecting from the incident segment of the reverse-circulation pathway to the optical feedback component via the reverse-drain optical pathway is a 0th order redirection, and wherein the reflective diffraction grating is configured such that redirecting the forward-source optical pathway, from the optical feedback component, to the ensuing segment of the forward-circulation pathway is a 0th order redirection.

Aspect 10: The ring-laser system of any of Aspects 1-9, wherein the reflective diffraction grating and the optical feedback component are bidirectionally coupled by the reverse-drain optical pathway and the forward-source optical pathway such that a portion of optical energy coupled out of the reverse-circulation pathway by the reverse-drain optical pathway is redirected into the forward-circulation pathway.

Aspect 11: The ring-laser system of any of Aspects 1-10, wherein the reflective diffraction grating and the optical feedback component are bidirectionally coupled by the reverse-drain optical pathway and the forward-source optical pathway such that the reverse circulation is augmented negatively and the forward circulation is augmented positively for establishing directional dominance along the forward-circulation pathway.

Aspect 12: The ring-laser system of any of Aspects 1-11, wherein the reflective diffraction grating and the optical feedback component are bidirectionally coupled by the reverse-drain optical pathway and the forward-source optical pathway such that greater effective optical gain is provided for the forward circulation on the forward-circulation pathway than for the reverse circulation on the reverse-circulation pathway, thereby producing a steady-state operating mode having a major portion of mode power in the forward-circulation pathway and a minor portion of the mode power in the reverse-circulation pathway.

Aspect 13: The ring-laser system of any of Aspects 1-12, wherein the ring cavity is configured to circulate light having a predetermined wavelength, and wherein the reflective diffraction grating is configured such that wavelengths that are different from the predetermined wavelength are directed outside of the forward-circulation path and the reverse-circulation path.

Aspect 14: The laser system of any of Aspects 1-13, wherein the ring cavity is configured to circulate light having a predetermined wavelength, and wherein the reflective diffraction grating is configured to disallow wavelengths that are different from the predetermined wavelength from being circulated within the ring cavity.

Aspect 15: The laser system of any of Aspects 1-14, wherein the ring cavity is configured to circulate light having a predetermined wavelength, and wherein the reflective diffraction grating is configured to disallow 2nd or higher order redirections from being circulated within the ring cavity.

Aspect 16: The laser system of any of Aspects 1-15, wherein the reflective diffraction grating has a grating period configured to circulate a predetermined wavelength within the ring cavity, output the predetermined wavelength along the forward-drain optical pathway, and disallow other wavelengths from circulating within the ring cavity.

Aspect 17: The laser system of any of Aspects 1-16, wherein the reflective diffraction grating is configured to use a back reflection from the optical feedback component to redirect energy from the reverse-circulation path into the forward-circulation path.

Aspect 18: The laser system of any of Aspects 1-17, wherein the reflective diffraction grating and the optical feedback component are configured to establish directional dominance along the forward-circulation path.

Aspect 19: The laser system of any of Aspects 1-18, wherein the reverse-drain optical path, from the reflective diffraction grating to the optical feedback component, is interior to an angle between an incident angle of forward-circulation path on the reflective diffraction grating and the forward-drain optical path.

Aspect 20: A ring-laser system for generating coherent optical radiation, comprising: a ring cavity comprising: three or more reflectors configured to provide a forward-circulation pathway delineating a forward circulation within the ring cavity and a reverse-circulation pathway delineating a reverse circulation within the ring cavity, the forward-circulation pathway and the reverse-circulation pathway being overlapping, counter-directional optical pathways; and a gain medium disposed within the ring cavity that is bidirectionally incorporated into the forward-circulation pathway and the reverse-circulation pathway; a forward-drain optical pathway for tapping a portion of light from the forward-circulation pathway; a reverse-drain optical pathway for tapping a portion of light from the reverse-circulation pathway as optical feedback; a forward-source optical pathway for inserting additional light into the forward-circulation pathway; and an optical feedback component configured to optically couple the reverse-drain optical pathway to the forward-source optical pathway, wherein the optical feedback, redirected from the reverse-drain optical pathway to the forward-source optical pathway by the optical feedback component, is configured to augment an optical signal in the forward-circulation pathway such that an optical mode in the forward-circulation pathway attains preferential gain in the gain medium relative to a corresponding optical mode in the reverse-circulation pathway.

Aspect 21: A free-space ring-cavity laser system for generating coherent optical radiation at a wavelength, comprising: a ring cavity configured to provide a forward-circulation pathway delineating a forward circulation within the ring cavity and a reverse-circulation pathway delineating a reverse circulation within the ring cavity; a gain medium disposed within the ring cavity that is bidirectionally incorporated into the forward-circulation pathway and the reverse-circulation pathway; an output pathway for coupling a portion of light from the forward-circulation pathway to a laser-system output; and a feedback pathway for unilaterally redirecting a portion of light from the reverse-circulation pathway into the forward-circulation pathway, wherein optical feedback on the feedback pathway is configured to establish a cavity mode of the forward circulation pathway at the wavelength as a dominant-power mode of the free-space ring-cavity laser system, and establish a cavity mode of the reverse-circulation pathway at the wavelength as an idle-power mode of the free-space ring-cavity laser system.

Aspect 22: A laser system, comprising: a ring cavity having a forward-circulation pathway and a reverse-circulation pathway for light of a predetermined narrow linewidth, the ring cavity including: a reflective diffraction grating that includes an output path from the ring cavity; a gain medium; and a plurality of reflectors; and a back reflector bidirectionally optically coupled with the reflective diffraction grating, wherein the reflective diffraction grating is configured to redirect light from the forward-circulation pathway to the output path, wherein the reflective diffraction grating is configured to redirect light from the reverse-circulation pathway to the back reflector, and wherein the reflective diffraction grating is configured to redirect light from the back reflector to the forward-circulation pathway.

Aspect 23: The laser system of Aspect 22, wherein the reflective diffraction grating is configured to redirect light from the forward-circulation pathway further along the forward-circulation pathway, wherein the reflective diffraction grating is configured to redirect light from the reverse-circulation pathway further along the reverse-circulation pathway, and wherein the reflective diffraction grating is configured to redirect light from the back reflector to the output path.

Aspect 24: The laser system of any of Aspects 22-23, wherein the reflective diffraction grating is configured to redirect all light from each incident direction to one of a 0th order redirection and a 1st order redirection.

Aspect 25: The laser system of any of Aspects 22-24, wherein the reflective diffraction grating is configured such that redirecting from the reverse-circulation pathway to the back reflector is a 0th order redirection, and wherein the reflective diffraction grating is configured such that redirecting from the back reflector to the forward-circulation pathway is a 0th order redirection.

Aspect 26: The laser system of any of Aspects 22-25, wherein the reflective diffraction grating is configured such that redirecting from the reverse-circulation pathway to the back reflector is a 0th order redirection, and wherein the reflective diffraction grating is configured such that redirecting from the reverse-circulation pathway to the reverse-circulation pathway is a 1st order redirection.

Aspect 27: The laser system of any of Aspects 22-26, wherein the reflective diffraction grating is configured such that redirecting from the back reflector to the output path is a 1st order redirection, and wherein the reflective diffraction grating is configured such that redirecting from the back reflector to the forward-circulation pathway is a 0th order redirection.

Aspect 28: The laser system of any of Aspects 22-27, wherein the reflective diffraction grating is configured such that redirecting from the forward-circulation pathway to the output path is a 0th order redirection, and wherein the reflective diffraction grating is configured such that redirecting from the forward-circulation pathway to the forward-circulation pathway is a 1st order redirection.

Aspect 29: The laser system of any of Aspects 22-28, wherein the back reflector is located between the ring cavity and the output path.

Aspect 30: The laser system of any of Aspects 22-29, wherein the ring cavity is configured such that wavelengths outside of the predetermined narrow linewidth are directed outside of the forward-circulation pathway and the reverse-circulation pathway.

Aspect 31: The laser system of any of Aspects 22-30, wherein the reflective diffraction grating is configured such that wavelengths outside of the predetermined narrow linewidth are directed outside of the forward-circulation pathway and the reverse-circulation pathway.

Aspect 32: The laser system of any of Aspects 22-31, wherein the reflective diffraction grating is configured such that wavelengths outside of the predetermined narrow linewidth are not coupled to the back reflector.

Aspect 33: The laser system of any of Aspects 22-32, wherein the ring cavity and the back reflector comprise a free space optical system.

Aspect 34: A laser system, comprising: a diffraction grating arranged at an output of a ring cavity and configured to couple output laser light, having a predetermine narrow linewidth, out of the ring cavity along an output path; a plurality of reflectors that, together with the diffraction grating, define the ring cavity, wherein the ring cavity is configured to operate in a startup operation mode and a steady-state operation mode, and wherein the ring cavity includes a forward-circulation pathway and a reverse-circulation pathway that is directionally counter to the forward-circulation pathway; a gain medium configured to generate laser light on the forward-circulation pathway and the reverse-circulation pathway of the ring cavity; and a back reflector optically coupled with the diffraction grating, wherein the diffraction grating and the back reflector are configured to, during the startup operation mode, redirect energy of the laser light, from the reverse-circulation pathway into the forward-circulation pathway such that, on each pass within the ring cavity, a total energy propagating along the reverse-circulation pathway is reduced and a total energy propagating along the forward-circulation pathway is increased, resulting in a steady-state condition corresponding to the steady-state operation mode, and wherein the ring cavity is configured to, during the steady-state operation mode, select the forward-circulation pathway as a dominant path for laser light in the ring cavity.

Aspect 35: The laser system of Aspect 34, wherein the diffraction grating is configured to use a back reflection from the back reflector to redirect the energy from the reverse-circulation pathway into the forward-circulation pathway.

Aspect 36: The laser system of any of Aspects 34-35, wherein the diffraction grating and the back reflector are configured to establish directional dominance along the forward-circulation pathway.

Aspect 37: The laser system of any of Aspects 34-36, wherein the diffraction grating is configured to disallow wavelengths that are outside of the predetermined narrow linewidth from being circulated within the ring cavity.

Aspect 38: The laser system of any of Aspects 34-37, wherein the diffraction grating is configured to disallow 2nd or higher order redirections from being circulated within the ring cavity.

Aspect 39: The laser system of any of Aspects 34-38, wherein the diffraction grating is a reflective diffraction grating having a grating period configured to circulate a predetermined wavelength within the ring cavity, output the predetermined wavelength along the output path, and disallow other wavelengths from circulating within the ring cavity.

Aspect 40: The laser system of any of Aspects 34-39, wherein the diffraction grating is a reflective diffraction grating having a grating period configured to: redirect a first portion of laser light from the reverse-circulation pathway to the back reflector as a 0th order redirection, redirect a second portion of laser light from the reverse-circulation pathway to the reverse-circulation pathway as a 1st order redirection, redirect a first portion of laser light from the back reflector to the forward-circulation pathway as a 0th order redirection, redirect a second portion of laser light from the back reflector to the output path as a 1st order redirection redirect a first portion of laser light from the forward-circulation pathway to the output path as a 0th order redirection, and redirect a second portion of laser light from the forward-circulation pathway to the forward-circulation pathway as a 1st order redirection.

Aspect 41: The laser system of any of Aspects 34-40, wherein the diffraction grating is a reflective diffraction grating having a grating period configured to: split laser light from the reverse-circulation pathway between a 0th order redirection to the back reflector and a 1st order redirection to the reverse-circulation pathway, split laser light from the back reflector between a 0th order redirection to the forward-circulation pathway and a 1st order redirection to the output path, and split laser light from the forward-circulation pathway between a 0th order redirection to the output path and a 1st order redirection to the forward-circulation pathway.

Aspect 42: A laser system, comprising: a diffraction grating arranged at an output of a ring cavity and configured to couple output laser light, having a predetermine narrow linewidth, out of the ring cavity along an output path; a plurality of reflectors that, together with the diffraction grating, define the ring cavity, wherein the ring cavity includes propagation paths, including a forward-circulation pathway and a reverse-circulation pathway, directionally counter to the forward-circulation pathway; a gain medium configured to generate laser light on the propagation paths of the ring cavity; and a back reflector optically coupled with the diffraction grating, wherein the diffraction grating is configured to use a back reflection from the back reflector to capture a first portion of the laser light from the reverse-circulation pathway, and redirect the first portion of the laser light into the forward-circulation pathway to generate a forward propagating light for producing the output laser light.

Aspect 43: The laser system of Aspect 42, wherein the diffraction grating is configured to create an energy imbalance between the reverse-circulation pathway and the forward-circulation pathway such that, among the forward-circulation pathway and the reverse-circulation pathway, the forward-circulation pathway becomes a dominant propagation path within the ring cavity.

Aspect 44: The laser system of any of Aspects 42-43, wherein the diffraction grating is configured to use the back reflection from the back reflector to capture a second portion of the laser light from the reverse-circulation pathway, and redirect the second portion of the laser light into the output path.

Aspect 45: The laser system of Aspect 44, wherein the diffraction grating is configured to: direct portions of laser light, including the first portion of the laser light and the second portion of the laser light, from the reverse-circulation pathway toward the back reflector, receive the portions of laser light, retroflected by the back reflector, from the back reflector, and split the portions of laser light into the first portion of the laser light and the second portion of the laser light.

Aspect 46: The laser system of Aspect 44, wherein the diffraction grating is configured to direct a third portion of the laser light from the reverse-circulation pathway further along the reverse-circulation pathway.

Aspect 47: The laser system of any of Aspects 42-46, wherein the diffraction grating is configured to couple a first portion of the laser light from the forward-circulation pathway further along the forward-circulation pathway, and couple a second portion of the laser light from the forward-circulation pathway into the output path.

Aspect 48: A system configured to perform one or more operations recited in one or more of Aspects 1-47.

Aspect 49: An apparatus comprising means for performing one or more operations recited in one or more of Aspects 1-47.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A ring-laser system for generating coherent optical radiation, comprising:
a ring cavity configured to provide a forward-circulation pathway delineating a forward circulation within the ring cavity and a reverse-circulation pathway delineating a reverse circulation within the ring cavity, the forward-circulation pathway and the reverse-circulation pathway being overlapping, counter-directional optical pathways, the ring cavity comprising:
at least three reflective junctions configured to provide optical coupling for providing the forward-circulation pathway and the reverse-circulation pathway; and
a gain medium that is bidirectionally incorporated into the forward-circulation pathway and the reverse-circulation pathway;
a forward-drain optical pathway delineating light coupled out of the forward-circulation pathway;
a reverse-drain optical pathway delineating light coupled out of the reverse-circulation pathway; and
a forward-source optical pathway delineating light to be coupled into the forward-circulation pathway;
a reflective diffraction grating disposed at a reflective junction of the at least three reflective junctions, the reflective diffraction grating configured to:
couple a first portion of an incident segment of the forward-circulation pathway to an ensuing segment of the forward-circulation pathway,
couple a second portion of the incident segment of the forward-circulation pathway to the forward-drain optical pathway,
couple a first portion of an incident segment of the reverse-circulation pathway to an ensuing segment of the reverse-circulation pathway,
couple a second portion of the incident segment of the reverse-circulation pathway to the reverse-drain optical pathway in order to augment the reverse circulation; and
couple a first portion of the forward-source optical pathway to the ensuing segment of the forward-circulation pathway in order to augment the forward circulation; and
an optical feedback component configured to optically couple the reverse-drain optical pathway to the forward-source optical pathway.

2. The ring-laser system of claim 1, wherein the reflective diffraction grating is configured to couple a second portion of the forward-source optical pathway to the forward-drain optical pathway.

3. The ring-laser system of claim 1, wherein the forward-drain optical pathway is a laser-system output path from which the coherent optical radiation is output from the ring-laser system.

4. The ring-laser system of claim 1, wherein the optical feedback component is a back reflector that is bidirectionally coupled to the reflective diffraction grating by the reverse-drain optical pathway and the forward-source optical pathway.

5. The ring-laser system of claim 1, wherein the optical feedback component is configured to back reflect the reverse-drain optical pathway back to the reflective diffraction grating as the forward-source optical pathway, the reverse-drain optical pathway and the forward-source optical pathway being overlapping, counter-directional optical pathways.

6. The laser system of claim 1, wherein the reflective diffraction grating is configured such that the forward-drain optical pathway, from the incident segment of the forward-circulation pathway, is a 0th order redirection, and the ensuing segment of the forward-circulation pathway, from the incident segment of the forward-circulation pathway, is a 1st order redirection.

7. The laser system of claim 1, wherein the reflective diffraction grating is configured such that the reverse-drain optical pathway, from the incident segment of the reverse-circulation pathway, is a 0th order redirection, and the ensuing segment of the reverse-circulation pathway, from the incident segment of the reverse-circulation pathway, is a 1st order redirection.

8. The laser system of claim 1, wherein the reflective diffraction grating is configured such that the ensuing segment of the forward-circulation pathway, from the forward-source optical pathway, is a 0th order redirection.

9. The laser system of claim 1, wherein the reflective diffraction grating is configured such that redirecting from the incident segment of the reverse-circulation pathway to the optical feedback component via the reverse-drain optical pathway is a 0th order redirection, and
wherein the reflective diffraction grating is configured such that redirecting the forward-source optical pathway, from the optical feedback component, to the ensuing segment of the forward-circulation pathway is a 0th order redirection.

10. The ring-laser system of claim 1, wherein the reflective diffraction grating and the optical feedback component are bidirectionally coupled by the reverse-drain optical pathway and the forward-source optical pathway such that a portion of optical energy coupled out of the reverse-circulation pathway by the reverse-drain optical pathway is redirected into the forward-circulation pathway.

11. The ring-laser system of claim 1, wherein the reflective diffraction grating and the optical feedback component are bidirectionally coupled by the reverse-drain optical pathway and the forward-source optical pathway such that the reverse circulation is augmented negatively and the forward circulation is augmented positively for establishing directional dominance along the forward-circulation pathway.

12. The ring-laser system of claim 1, wherein the reflective diffraction grating and the optical feedback component are bidirectionally coupled by the reverse-drain optical pathway and the forward-source optical pathway such that greater effective optical gain is provided for the forward circulation on the forward-circulation pathway than for the reverse circulation on the reverse-circulation pathway, thereby producing a steady-state operating mode having a major portion of mode power in the forward-circulation pathway and a minor portion of the mode power in the reverse-circulation pathway.

13. The ring-laser system of claim 1, wherein the ring cavity is configured to circulate light having a predetermined wavelength, and
wherein the reflective diffraction grating is configured such that wavelengths that are different from the predetermined wavelength are directed outside of the forward-circulation path and the reverse-circulation path.

14. The laser system of claim 1, wherein the ring cavity is configured to circulate light having a predetermined wavelength, and
wherein the reflective diffraction grating is configured to disallow wavelengths that are different from the predetermined wavelength from being circulated within the ring cavity.

15. The laser system of claim 1, wherein the ring cavity is configured to circulate light having a predetermined wavelength, and
wherein the reflective diffraction grating is configured to disallow 2nd or higher order redirections from being circulated within the ring cavity.

16. The laser system of claim 1, wherein the reflective diffraction grating has a grating period configured to circulate a predetermined wavelength within the ring cavity, output the predetermined wavelength along the forward-drain optical pathway, and disallow other wavelengths from circulating within the ring cavity.

17. The laser system of claim 1, wherein the reflective diffraction grating is configured to use a back reflection from the optical feedback component to redirect energy from the reverse-circulation path into the forward-circulation path.

18. The laser system of claim 1, wherein the reflective diffraction grating and the optical feedback component are configured to establish directional dominance along the forward-circulation path.

19. The laser system of claim 1, wherein the reverse-drain optical path, from the reflective diffraction grating to the optical feedback component, is interior to an angle between an incident angle of forward-circulation path on the reflective diffraction grating and the forward-drain optical path.

20. The laser system of claim 1, further comprising:
a reverse-source optical pathway,
wherein the reverse-source optical pathway and the forward-drain optical pathway are overlapping, counter-directional optical pathways, and
wherein the reflective diffraction grating is configured to couple the reverse-source optical pathway to the ensuing segment of the reverse-circulation pathway for inserting additional light into the reverse-circulation pathway and to augment the reverse circulation of the reverse-circulation pathway.

21. A ring-laser system for generating coherent optical radiation, comprising:
a ring cavity comprising:
three or more reflectors configured to provide a forward-circulation pathway delineating a forward circulation within the ring cavity and a reverse-circulation pathway delineating a reverse circulation within the ring cavity, the forward-circulation pathway and the reverse-circulation pathway being overlapping, counter-directional optical pathways; and
a gain medium disposed within the ring cavity that is bidirectionally incorporated into the forward-circulation pathway and the reverse-circulation pathway;
a forward-drain optical pathway for tapping a portion of light from the forward-circulation pathway;
a reverse-drain optical pathway for tapping a portion of light from the reverse-circulation pathway as optical feedback;
a forward-source optical pathway for inserting additional light into the forward-circulation pathway; and
an optical feedback component configured to optically couple the reverse-drain optical pathway to the forward-source optical pathway,
wherein the optical feedback, redirected from the reverse-drain optical pathway to the forward-source optical pathway by the optical feedback component, is configured to augment an optical signal in the forward-circulation pathway such that an optical mode in the forward-circulation pathway attains preferential gain in the gain medium relative to a corresponding optical mode in the reverse-circulation pathway.

22. A free-space ring-cavity laser system for generating coherent optical radiation at a wavelength, comprising:
a ring cavity configured to provide a forward-circulation pathway delineating a forward circulation within the ring cavity and a reverse-circulation pathway delineating a reverse circulation within the ring cavity;
a gain medium disposed within the ring cavity that is bidirectionally incorporated into the forward-circulation pathway and the reverse-circulation pathway;
an output pathway for coupling a portion of light from the forward-circulation pathway to a laser-system output; and
a feedback pathway for unilaterally redirecting a portion of light from the reverse-circulation pathway into the forward-circulation pathway,
wherein optical feedback on the feedback pathway is configured to establish a cavity mode of the forward circulation pathway at the wavelength as a dominant-power mode of the free-space ring-cavity laser system, and establish a cavity mode of the reverse-circulation pathway at the wavelength as an idle-power mode of the free-space ring-cavity laser system.
